(19) United States
(12) Patent Application Publication
(10) Pub. No.: US 2009/0192785 A1
(43) Pub. Date: Jul. 30, 2009

(54) SYSTEM AND METHOD FOR OPTIMIZING NATURAL LANGUAGE DESCRIPTIONS OF OBJECTS IN A VIRTUAL ENVIRONMENT

(76) Inventors: Anna Carpenter Cavender, Seattle, WA (US); Mark Richard Laff, Goldens Bridge, NY (US); Sharon Mary Trewin, Croton-on-Hudson, NY (US)

Correspondence Address: KEUSEY, TUTUNJIAN & BITETTO, P.C., Suite 210, 20 Crossways Park North, Woodbury, NY, 11797, US

(21) Appl. No.: 12/021,472

(22) Filed: Jan. 29, 2008

(51) Int. Cl. G06F 17/27

(52) U.S. Cl. 704/9

(57) ABSTRACT

A system and method for constructing a natural language description of one or more objects in a virtual environment includes determining a plurality of properties of an object and an environment given a current viewpoint in a virtual environment. An object description is created using the plurality of properties where the object description reflects multiple display characteristics of the object in the virtual environment. Object descriptions in the virtual environment are combined by classifying objects in the virtual environment to condense a natural language description.

### BACKGROUND

1. Technical Field

The present invention relates to virtual environments and more particularly to systems and methods for optimizing a natural language description of a specific object or scene within a virtual environment.

2. Description of the Related Art

Virtual environments comprise computer-generated three-dimensional (3D) renderings of a 3D world model that may be based on a real environment, or represent an artificial environment. The environment is typically composed of a set of virtual objects, each of which has a particular location and orientation within the environment. A user of a virtual environment also has a specific location and orientation within the environment, which may be represented by an avatar placed at the appropriate location within the environment. This location and orientation provides a viewpoint from which the user views a scene in the environment.

As described by Lipkin in U.S. Pat. No. 6,348,927, a view of a virtual environment can be presented to a user by consulting a database of objects, finding a relevant subset of objects, and rendering those objects visually to provide a graphical view of the environment. Users who cannot see well do not have access to this view. This includes both users who have a visual impairment, and users who are accessing the virtual environment through devices with limited graphics capabilities.

Sofer, in U.S. Patent Application No. 2006/0098089A1, teaches the use of a 3D model in combination with image processing to identify objects in a real environment, and audibly describes those objects to a person. Objects to be described are ordered according to their distance from the user, with nearer objects described first. Objects are described in natural language using names that are provided by a human in advance. In a complex environment, there may be many such objects in view.

There are two primary limitations in this approach. First, the name used to describe an object is static, but the appearance of the object within the environment changes depending on the user's viewpoint. Different features of the object may be hidden or visible, and the object may be partially occluded by other objects. Furthermore, the object may change its appearance based on the values of properties of the object. For example, a lamp may be on or off.

One known method for providing a text description that is accurate with respect to the state of a control object in a two-dimensional user interface is to provide a set of descriptions in advance, and select the appropriate description based on the state of the object at the time the description is requested. However, this method does not provide for descriptions that are sensitive to other factors such as a viewer's location with respect to the object, or to the state of the surrounding environment. This results in non-optimal, and even potentially misleading, descriptions.

A second factor that causes natural language descriptions of a scene to be sub-optimal is the complexity of the environment. If there are many objects to be described, the scene description becomes too long. In other applications involving large numbers of objects, object numbers are structured in a hierarchy, as taught by US 2006/019843B A1 to Negishi et al.

U.S. Pat. No. 6,329,986 to Cheng teaches a method of prioritizing a set of objects within a virtual environment to determine which objects to present to the user, and the quality of the presentation. Priority is determined using base and modifying parameters, where the modifying parameters represent circumstances, views, characteristics, and opinions of the participant. Base parameters can represent a characteristic of the environment, distance to the object, angle between the center of the viewpoint and the object, and the ‘circumstance of’ a user interaction with an object. Cheng does not teach the use of the prioritization to order objects for presentation.

U.S. Pat. No. 6,118,456 teaches a method of prioritizing objects within a virtual environment, according to their importance within a scene from a particular viewpoint. This prioritization is used to determine the order in which object data is fetched from a remote server, so that important objects are rendered more quickly than less important objects. Object importance is calculated by considering the distance to the object, the visual area taken up by the object in the scene, the user's inferred area of visual focus, object movement, and an application-specific assigned ‘message’ value that is used to elevate the importance of specific objects.

These grouping and prioritization techniques have not been applied to the problem of optimizing a natural language description of a scene within a virtual environment. Furthermore, these techniques do not include consideration of several factors that contribute to an efficient scene description.

### SUMMARY

One factor for efficient scene description includes the set of recent descriptions given to the user. In human communication, long descriptions are generally condensed when repeated. For example, the phrase “a red chair with four green legs” may be used the first time such a chair is described, whereas subsequent descriptions would take the form “a red chair” or, eventually, “another chair” or “five more chairs”. If five identical chairs have already been described to the user, it is preferable to group other similar chairs and describe them with a single phrase. Furthermore, conventional algorithms also do not take into account the other objects present in the scene, except to calculate whether an object is visible to the user. In a scene with hundreds of chairs, a single chair should not be given a high priority, whereas in a meeting room, it should.

In accordance with the present principles, a system and method of generating a natural language description of an object within a 3D model that is accurate with respect to the object's location, the viewer's viewpoint, recent activity, and the state of the object and surrounding environment are provided.

Another method by which such descriptions are composed into a scene description and presented to a user is constructed so as to limit the total number of objects described, and to describe more important objects before less important objects. Such a description is useful to help introduce and orient users who, for whatever reason, cannot see the visual representation of the virtual environment. In the context of virtual environments, a method that overcomes the shortcomings of existing techniques for describing a virtual scene in words is provided.

A system and method for constructing a natural language description of one or more objects in a virtual environment include determining a plurality of properties of an object and an environment given a current viewpoint in a virtual environment; creating an object description using the plurality of properties where the object description reflects multiple display characteristics of the object in the virtual environment; and combining object descriptions by classifying objects in the virtual environment to condense a natural language description.

Another system and method for constructing a natural language description of an object in a three-dimensional (3D) virtual model includes determining a plurality of properties of an object and an environment given a current viewpoint in a virtual environment; creating an object description using the plurality of properties where the object description reflects multiple display characteristics of the object in the virtual environment including at least one of an angle from which the object is viewed; a distance of the object from the viewpoint; a portion of the object that is visible from the viewpoint; and values of properties of other objects also present in the environment; classifying objects in the virtual environment to optimize a natural language description of a virtual scene including at least one of replacing sets of similar objects with a single group object and a corresponding natural language description, prioritizing a set of objects and filtering the set of objects; and outputting the natural language description of the virtual scene as synthesized speech.

A system in accordance with the present principles constructs a natural language description of one or more objects in a virtual environment. A processing system is configured to generate an object and an environment in a virtual rendering, to determine a plurality of properties of the object and the environment given a current viewpoint in the virtual environment, and to create an object description using the plurality of properties where the object description reflects multiple display characteristics of the object in the virtual environment. The one or more memory storage devices or memory in the processing unit is/are configured to provide constructions, templates or other formats for combining object descriptions by classifying objects in the virtual environment in accordance with stored criteria. This is employed to condense a natural language description of the virtual environment. An output device is configured to output the natural language description.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram depicting an exemplary system/method for generating a description of an object in a 3D environment according to the present principles;

FIG. 2 is a block/flow diagram depicting an exemplary system/method for composing an object description;

FIG. 3 is a block/flow diagram depicting an exemplary system/method for object description components, from which object descriptions are composed;

FIG. 4 is a block/flow diagram depicting an exemplary system/method for generating a prioritized list of object descriptions;

FIG. 5 is a block/flow diagram depicting an exemplary system/method for filtering a set of objects in greater detail;

FIG. 6 is a block/flow diagram depicting an exemplary system/method for prioritizing a set of objects in greater detail;

FIG. 7 is a block/flow diagram depicting an exemplary system/method for creating groups within a set of objects in greater detail;

FIG. 8 is a block/flow diagram depicting an exemplary system/method for generating descriptions for a set of objects in greater detail;

FIG. 9 is a block/flow diagram depicting an exemplary system/method for generating a single description for an object that represents a group of objects;

FIG. 10 is a block/flow diagram depicting an exemplary system/method for a user interaction with a system employing FIG. 4 to provide a user with a natural language description of a scene in a virtual environment; and

FIG. 11 is a block diagram depicting an exemplary system to provide a user with a natural language description of a scene in a virtual environment.

### DETAILED DESCRIPTION OF PREFERRED EMBODIMENTS

In accordance with illustrative embodiments, a system and method for generating a natural language description of an object within a 3D model that is accurate with respect to the object's location, a viewer's viewpoint, recent activity, and a state of the object and surrounding environment are provided. Such descriptions are composed into a scene description and presented to a user. This scene description is constructed so as to limit the total number of objects described, and to describe more important objects before less important objects. Such a description is useful to help introduce and orient users who, for whatever reason, cannot see the visual representation of the virtual environment, or for other reasons.

According to one aspect, a system and method are provided for obtaining a natural language description of an individual object within a virtual environment. The description is constructed by considering the distance between the viewpoint and the object, the angle between the center of view and the object, the portion of the object that is visible from the viewpoint, the values of properties of other objects present in the environment, the value of properties of the object itself, and the object descriptions that have already been provided to the user.

According to a further aspect, a set of objects to be described is identified, the number of objects is reduced or condensed by grouping subsets of similar objects, and the objects are prioritized. Natural language descriptions of the resulting set of objects and groups are generated. This may be performed in any order, and may be repeated.

Filtering of the set of objects to be considered may be performed at any stage. For example, an initial set may include only objects that are visible from the user's current viewpoint, or only objects with certain properties. Finally, the set of natural language descriptions is presented to the user. This presentation may take the form of a single natural language description composed from the individual descriptions, or it may include a set of individual descriptions. This presentation may also involve the use of 3D audio properties to reflect the location of each object, the use of synthesized speech to speak the objects to the user, or any other method of communicating natural language text to a user.

The user may interrupt the presentation of the description, and the object being described at the point of interruption will be stored for use in further processing. For example, the user may set this object as a target they can then navigate to. The generation of the natural language description of a scene may be triggered by a user command, by the action of moving to a specific viewpoint, a particular state of the environment, or a particular state of the user within that environment.

Various features may be used to guide the prioritization of objects within the environment. Specifically, prioritization may be affected by: the degree of fit between a user's query and objects, the location relative to the viewpoint, the size of the object, the proportion of the view occupied by the object, visual properties of the object in the scene, the type of the object, metadata associated with the object, a text name and description associated with the object, the object's velocity, acceleration and orientation, the object's animation, the user's velocity, acceleration and direction of movement, previous descriptions provided to the user, and/or other objects present in the scene.

Embodiments in accordance with the present principles may be employed in video games, virtual tours, navigation systems, cellular telephone applications or other computer or virtual environments where a verbal description of a displayed or displayable scene needs to be audibly described. The present embodiments may be employed to provide explanation in a virtual environment which matches an actual environment, such as in a navigation application or virtual tour. In other embodiments, people with visual impairments will be able to hear a verbal (natural speech) description of a virtual environment or a virtual model of a real environment.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Objects as referred to herein include virtual objects that are rendered or are renderable on a screen, display device or other virtual environment. Such objects may also include software representations. The objects may be rendered visually or acoustically to be perceived by a user.

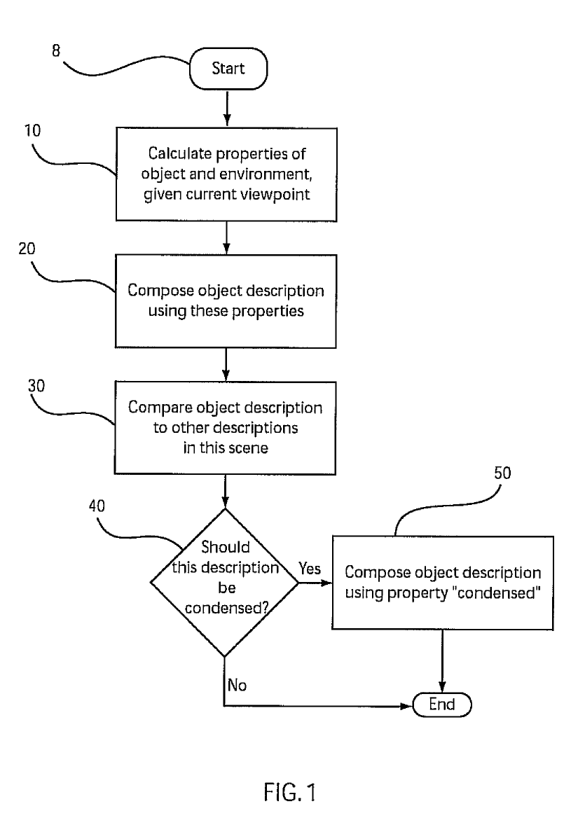

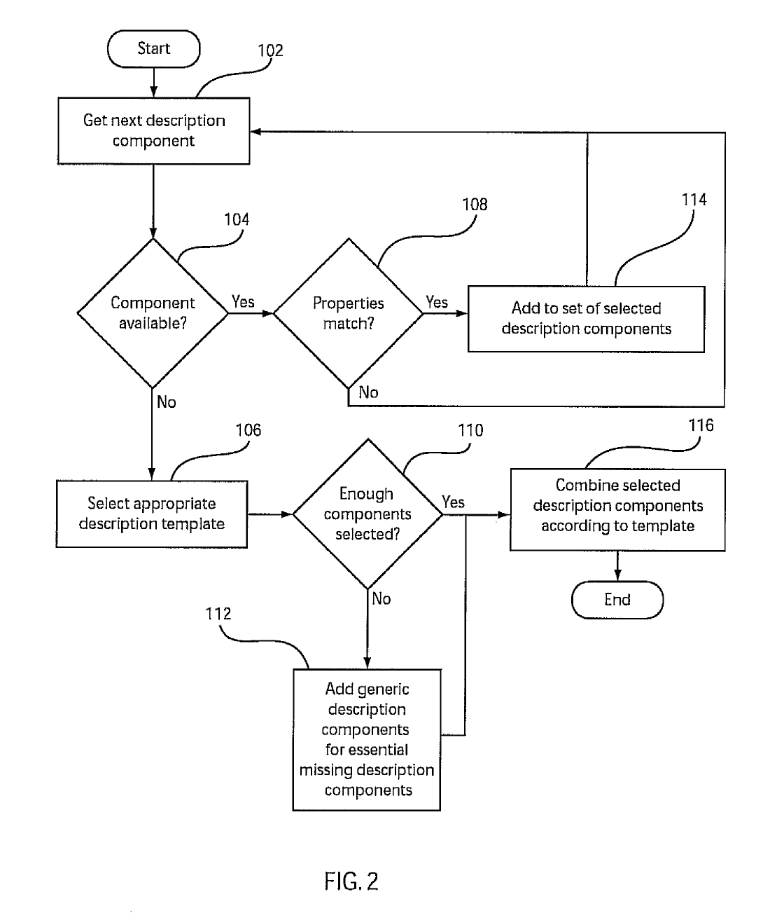

Referring now to the drawings in which like numerals represent the same or similar elements and initially to FIG. 1, a block/flow diagram of an exemplary system/method (which can be computer-implemented) for generating a description of an object in a virtual environment is illustratively shown. After beginning at block 8, properties of an object are calculated, and properties of an environment are calculated in block 10. These properties are determined given a current viewpoint. The viewpoint includes a location and orientation in the virtual environment. Examples of properties that may be calculated include: a distance of the object from the viewpoint; an angle between the center of gaze and the object as seen from the viewpoint; a portion of the object that is visible from the viewpoint; a portion of the view that is occupied by the object, properties of the object such as velocity, acceleration and direction of movement; static or dynamic tags associated with the object; a class of the object (for example ‘a wheeled vehicle’, ‘an avatar’); properties of the environment such as a number of nearby objects of the same class, or a number of moving objects in the current view; and other relevant features. In block 20, these calculated properties are then used to compose a natural language description of the object. This is further described in FIG. 2.

In block 30, the composed object description is compared to other object descriptions. These may be descriptions already calculated for objects in a current set of objects, or descriptions that have already been generated and provided to the user. In block 40, a decision is made as to whether the current description should be condensed. In one embodiment, a description is condensed if it is identical to one of the other object descriptions. In another embodiment, the description is condensed if it is greater than a certain length threshold, and judged as similar to a threshold number of other descriptions, and judged as being of lower priority compared to those descriptions, where priority may be equated with distance from the viewpoint or some other property or combination of properties. If the description is judged to be one that should be condensed, then in block 50, the property of ‘condensed’ is applied to it, and the method of FIG. 2 is employed to produce a condensed description. The resulting condensed description is then the final generated object description. If the description does not need to be condensed, the object description generation is complete.

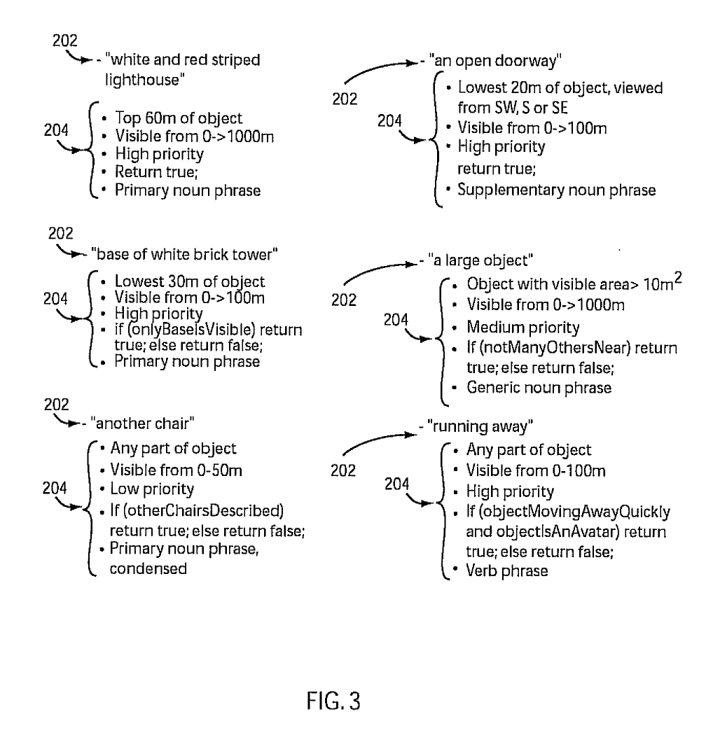

Referring to FIG. 2, a block/flow diagram describes block 20 of FIG. 1 in greater detail. The properties calculated as described above are used to compose a natural language description of the object. In this embodiment, objects have description components associated with them. These description components are natural language text fragments, from which a final description is constructed. Furthermore, the components have properties associated with the components, indicating the situations in which they are relevant to the description of the object. Examples of such description components are illustratively provided in FIG. 3. Object description composition proceeds by finding description components in block 104. If a description component is found, the properties associated with the component are compared with the properties calculated in block 10 of FIG. 1. Properties are considered to match if the object's properties fall within the ranges specified for the description component properties in block 108. Further explanation of property matching is provided with respect to FIG. 3.

If the properties match, the description component is added to a list of description components that match the current object's properties in block 114. The next description component is then fetched in block 102 and examined in the same way, until all available description components have been examined.

When no more description components are available, a description template is selected in block 106, into which the components will be placed. Selection of this template may be based on the type of the object, the number and type of description components selected, or other criteria. When the template has been selected, the components needed to instantiate the template are compared with the set of selected components. If needed components are missing as determined in block 110, then generic object description components are fetched to fill these roles in block 112. For example, if no description components are available for an object, the generic component “unknown object” could be selected. This selection may include, for example, the same property matching approach described above with reference to FIG. 2, block 108. Generic components could also be more specialized, such as “unknown blue object” or “large building”. Finally, these components are combined into an object description using the template in block 116. One example of a template could be a natural language sentence generated from a grammar. Another example is a sentence with missing items, where the type of item needed to fill each empty slot is indicated in the template. For example the template “<Primary Noun Phrase> with <Secondary Noun Phrase> <Verb Phrase>” could be instantiated with three description components to give the object description “White and red striped lighthouse with an open doorway sending out rotating beams of light.”

Referring to FIG. 3, several examples of object description components 202 and their associated properties 204 are illustratively provided. These properties 204 include an indication of the portion of the object the description applies to. It should be understood that different properties and property formats may be employed.

If this portion of the object is not visible, this description component will not be selected. Another property is the direction from which the feature being described is visible. So for example, the door of the lighthouse is only visible from the South West, South or South East. If the viewpoint is not from one of these directions, this component will not be selected. Another property is the distance range from which the component is visible. This enables some features to be described only when the viewpoint is near. Another feature is a priority value for the component. More important components will take priority over less important ones. Another feature that may be provided is a relevance function or expression that calculates whether the description component is relevant to the current situation. This calculation would be based on the object properties calculated as described with respect to FIG. 1.

An example of such a calculation is a function that evaluates a component to be relevant when only the base of the tower is visible, or when the object in question is an avatar moving away from the viewpoint. Description components also include a property that indicates the type of component. This is used as described in FIG. 2 to determine how to use the component in a full description. Examples of such types are ‘primary noun phrase’, ‘secondary noun phrase’, ‘adjective’, ‘verb phrase’, etc.

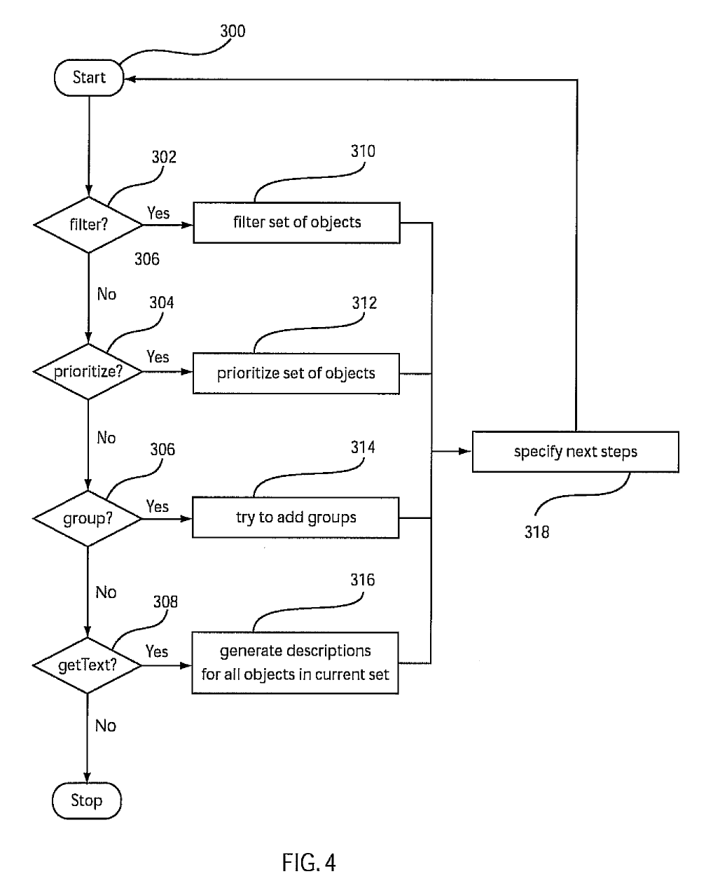

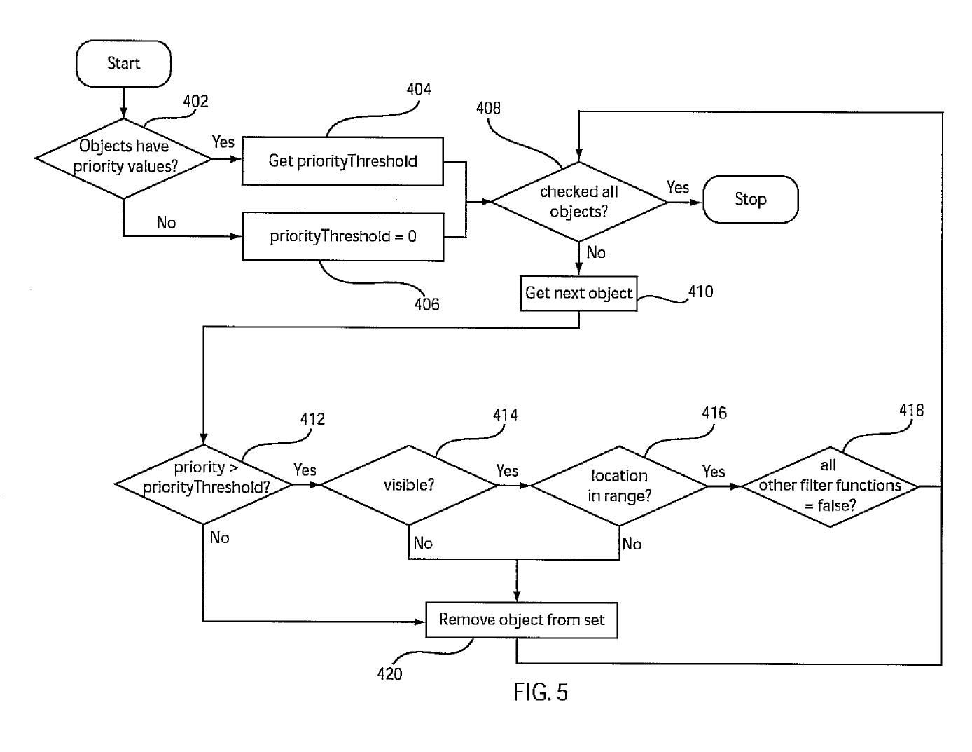

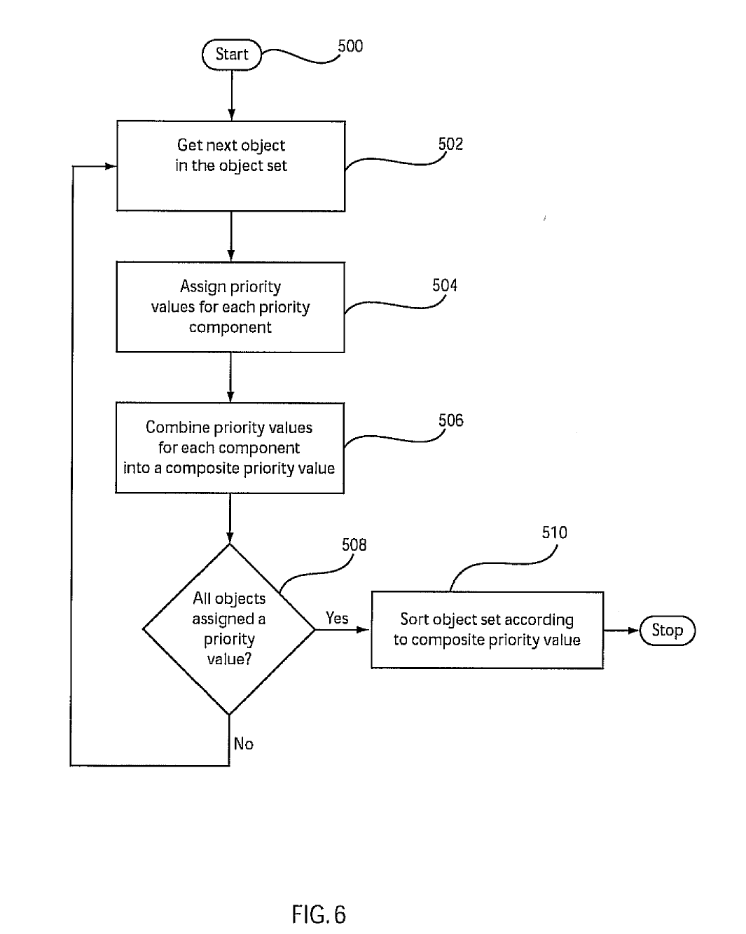

Referring to FIG. 4, a block/flow diagram is illustratively depicted of an exemplary system/method for generating a prioritized list of object descriptions, where the object descriptions themselves are generated using the method of FIG. 1. Four variables: filter (block 302), prioritize (block 304), group (block 306) and getText (block 308), may be used to control the order and number of steps through the method. An initial set of objects is provided at the start in block 300. This may be the set of objects within the field of view. Starting in block 302, a decision is made as to whether the set of objects should be filtered. If the ‘filter’ variable has a non-zero value, then filtering is needed, and the set of objects is filtered in block 310, as described in FIG. 5, to produce a reduced set of objects. If filtering is not needed, as indicated by the value of the ‘filter’ variable, control passes to block 304, where a prioritize variable is examined. If the value of the prioritize variable indicates that prioritization of the current set of objects is needed, control passes to block 312, in which the object prioritization is carried out as described in FIG. 6. After block 312, the set of objects is ordered in a list, with the most important object first.

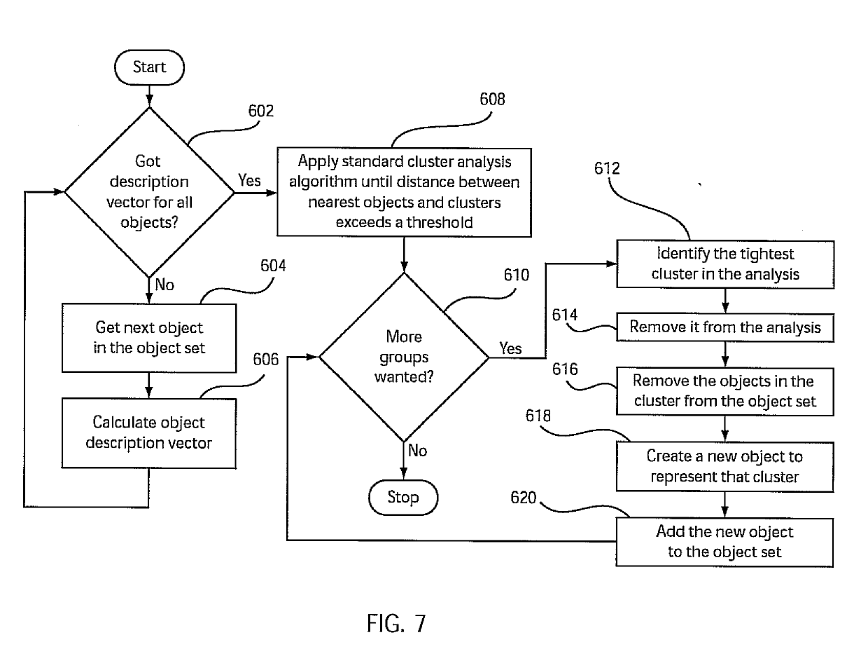

If filtering and prioritization are not needed, then the group variable is examined in block 306. If the value of the group variable indicates that grouping is needed, control passes to block 314 where grouping is carried out as described in FIG. 7. After block 314 is completed, the set of objects may include one or more new objects that are formed of groups of the original objects. Objects that are included in a group are removed from the object set.

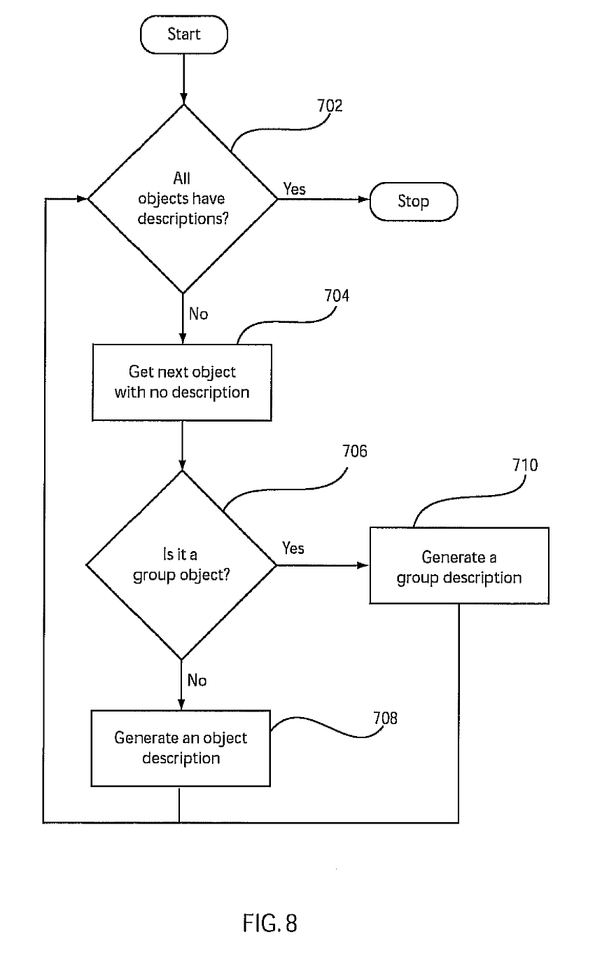

If grouping is not needed, then the getText variable is examined in block 308. If the value of the getText variable indicates that text should be generated, then control passes to block 316 in which natural language descriptions of all of the objects in the current set are generated according to FIG. 8. The result is a set of objects in which all the objects, including those that are groups, have a natural language description associated with them. If text is not needed, the method is complete and the current set or ordered list of objects is returned.

After filtering, prioritization, grouping or text generation has been performed, control then passes to block 318 where the control variables filter, prioritize, group and getText are updated to reflect the desired next steps in the procedure. Control passes back to the start in block 300. The values of the filter, prioritize, group and getText variables may be manipulated to produce any order or number of repetitions of the steps.

One procedure may filter objects to remove those that are not visible from the current viewpoint, then try to add groups, prioritize the resulting set, filter again to remove low priority items, and then generate descriptions for the remaining items. An alternative is to generate text for the items before grouping, to use the generated text as the basis for grouping decisions. Other procedures are also contemplated.

Referring to FIG. 5, a block/flow diagram depicts an exemplary system/method for filtering a set of objects according to a set of filter functions. A filter function may return a binary value indicating whether the current object should be filtered or retained. Initially, in block 402, the object set is examined to see whether the objects have already been assigned priority values. If so, in block 404, a priority threshold is set according to the requirements of the application. If not, in block 406, the priority threshold is set to 0. Next, in block 408, a check is made to see whether all objects in the set have been examined. If so, the system/method halts. If not, the next object is fetched at block 410. The priority of the object is compared with the priority threshold in block 412. If the object has a priority lower than the threshold, it is removed from the set at block 420. If it has a priority at least as high as the threshold, a second filter function is applied in block 414.

This filter function checks whether the object is visible from a current viewpoint. If not, the object is again removed from the set in block 420. If the object passes this test, a third filter function is applied in block 416, which tests whether the object is within a certain range of the viewpoint. Objects outside this range are again removed from the set in block 420. Additional (or fewer) filter functions may be applied as illustrated in block 418. In some embodiments, only one filter function is applied. Any object that fails to pass a filter is removed from the set (block 420). Control then passes back to blocks 408 and 410 to get the next object. When all objects have been examined, the set of objects remaining in the set is returned as the filtered set.

Referring to FIG. 6, a block/flow diagram depicts an exemplary system/method for prioritizing a set of objects. At start in block 500, a set of objects is provided. Next, one object without an up-to-date priority value is selected from this set in block 502. This object is then assigned a priority value for each of a number of desired priority components in block 504. Priority components might include values based on the distance of the object from the viewpoint, the proximity of the object to the center of the view, the number of other similar objects in the view, tags associated with the object indicating the importance of the object, or any other features deemed relevant. These priority values are combined at block 506 to produce a single composite priority value for the object. Next, a check is made to see whether all objects in the initial set have been assigned a priority value in block 508. If not, another object is selected in block 502 and the process repeated until all objects have been assigned priority values. When all objects have up-to-date priority values, the set is sorted according to these values, to produce an ordered list of objects in block 510.

Referring to FIG. 7, a block/flow diagram depicts an exemplary system/method for replacing two or more objects within a set of objects with a single group object that represents them all. An initial set of objects may also include groups. In block 602, a check to see if all objects already have a description vector is performed. If not, get the next object from the set that has no description vector in block 604 and, generate a description vector for the object in block 606. A description vector is a set of features that are used to base similarity decisions for objects. Elements within the vector reflect features such as the type of an object, the distance and orientation, etc.

When all objects have a description vector, standard cluster analysis algorithms known in the art may be applied to the set of objects to identify groups of similar objects in block 608. Control then passes to block 610, where a decision is made as to whether more groups are needed. This decision may be based on comparing the total number of objects in the set with a predefined ideal maximum number of objects. Coherence and size of the tightest cluster in the cluster analysis may also be taken into account. If the total number of objects is below the target level, or no suitable cluster has been identified, more groups are not needed. The system/method terminates, and the current set of objects (including any groups) is returned.

If more groups are desired, control passes to block 612, in which the tightest cluster in the analysis is identified. This is the set of objects with minimum distance between them according to the output of the cluster analysis. This group of objects is then removed from the cluster analysis in block 614, and the items in the cluster are removed from the set of objects in block 616.

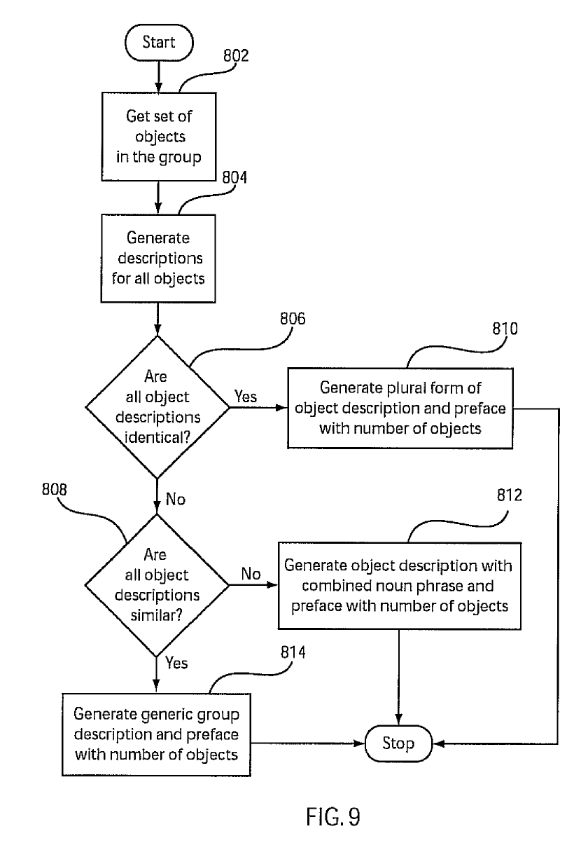

A new object is created to reflect the group in block 618. This new object includes information about the objects in the group. For example, it the objects already have text descriptions, a group text description is generated at this stage, according to the steps outlined in FIG. 9. In block 620, this new object is then added to the object set, and the resulting object set is checked to see whether further grouping is desired.

Referring to FIG. 8, a block/flow diagram depicts an exemplary system/method for generating a description for all objects in a set. Starting with an initial set of objects, some of which may be objects that represent groups, the set of objects is inspected to see whether all the objects have descriptions in block 702. If not, in block 704, the next object with no description is selected. If it is a group object as determined in block 706, a group description is generated in block 710 and according to FIG. 9. If it is not a group, an object description is generated in block 708 and according to FIG. 1.

After a description or group description has been generated, the set of objects is again tested (block 702) to see if further objects need descriptions. When all objects have descriptions, the system/method terminates.

Referring to FIG. 9, a block/flow diagram depicts an exemplary system/method for generating a natural language description for an object that represents a group of objects. In block 802, a set of objects in a group is fetched. In block 804, descriptions for each of those objects are obtained. These may be already associated with the objects, or generated at this stage according to the steps of FIG. 8. Next, the object descriptions are compared in block 806. If all descriptions are identical, control passes to block 810 where a plural form of the description is generated. This may be achieved by pluralizing the main noun phrase in the description using natural language generation techniques that are known in the art, and prefacing with a determiner that indicates the number of objects in the group. For example, a group of 5 objects with the description “a green lounge chair” could be given a group description of “Five green lounge chairs”. Once this description has been generated, the program path terminates, and the group description is returned as the chosen description for the group.

If the object descriptions are not all identical, the degree of similarity is assessed in block 808. If the descriptions are sufficiently similar (for example the primary noun is the same in all cases), a group description is generated, by e.g., combining the primary noun phrases and prefacing with the number of objects. For example, “Seven chairs and tables”. It should be understood that more sophisticated ways to provide a group description may be employed, e.g., using an ontology to identify a common superclass and getting a description for that superclass, or finding the “correct” collective noun phrase (e.g. “a crowd of people” or “several items of furniture”). Condensing descriptions extends to other parts of speech, idiomatic phrases, and the like.

The description is then returned from block 812. If the descriptions are not sufficiently similar for this merging, a more generic group description is produced in block 814. This may be a generic object description that matches all of the objects in the group. Again, this may be prefaced with the number of objects represented in the group. For example “Fifty large metal objects.” Other embodiments may provide for alternative schemes for generating the group descriptions, including the use of group templates, or group phrases explicitly provided as object description components. In another embodiment, description components for groups are explicitly defined in the same way as object description components.

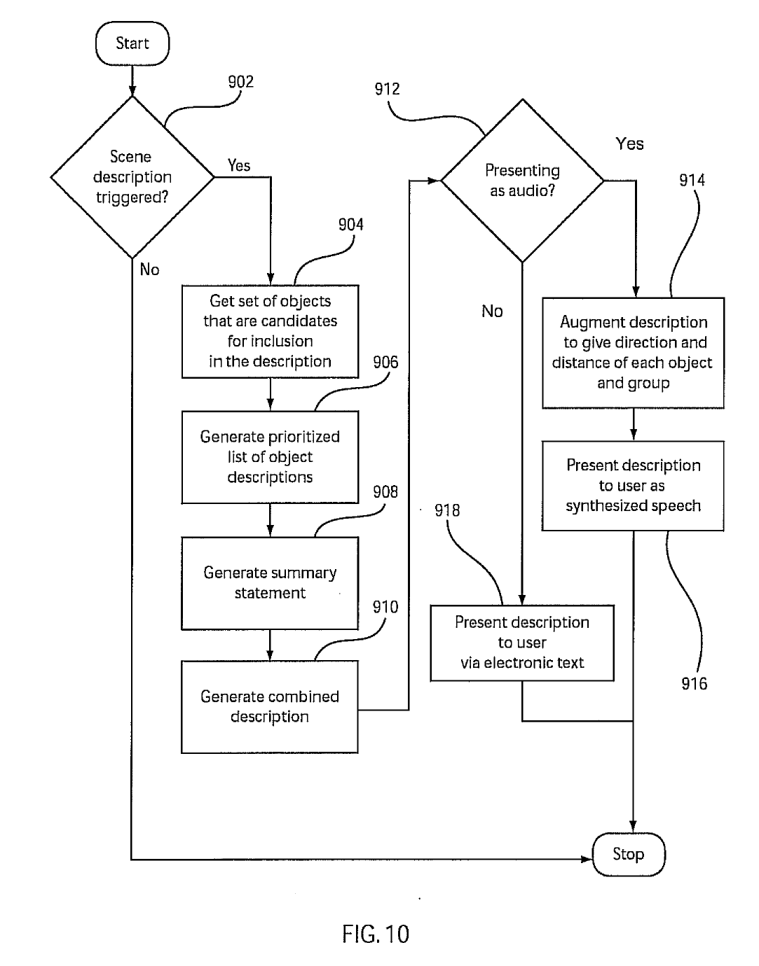

Referring to FIG. 10, a block/flow diagram depicts an exemplary system/method for application of the techniques described above in a virtual environment user interface to provide natural language descriptions of the objects in the environment. When a scene description is triggered in block 902, either by user command, user action, or other means, an initial set of objects present in the virtual environment is obtained in block 904. These may be all the objects in the environment, only the objects in a certain portion of the environment, or only objects that are at least partly visible from the current viewpoint. Next, in block 906, a prioritized list of object descriptions is generated according to FIG. 4.

In block 908, a summary statement for the object list is generated to provide an overview of the scene. This may be generated from a template that calls out specific object types. For example “5 avatars, 6 villains nearby, 2 buildings and 35 other objects”. In another embodiment, the summary provides orienting information such as “North side of Wind Island, facing East. Standing on grass. Cloudy sky above.” In block 910, the summary statement is combined with the prioritized list of object descriptions to produce a final natural language description. This step of combining the descriptions may include removing objects from the list that have been described in the summary statement (e.g. sky, grass). It may also include the addition of information about the relative positions of objects in the list. For example, “a golden haired woman sitting in a green armchair”.

In block 912, the resulting statement may be presented to a user as audio, in which case some embodiments will attach 3D audio information to the items in the list such that their audio representation reflects the distance and location of the object relative to the viewpoint in block 914. For example, a distant object on the left could be described using a low volume in the left ear. The description may be presented to the user as synthesized speech, in block 916. If audio presentation is not desired, the description can be provided as electronic text to be rendered in a manner of the user's choosing in block 918. For example, it may be converted into Braille and provided via a refreshable Braille display.

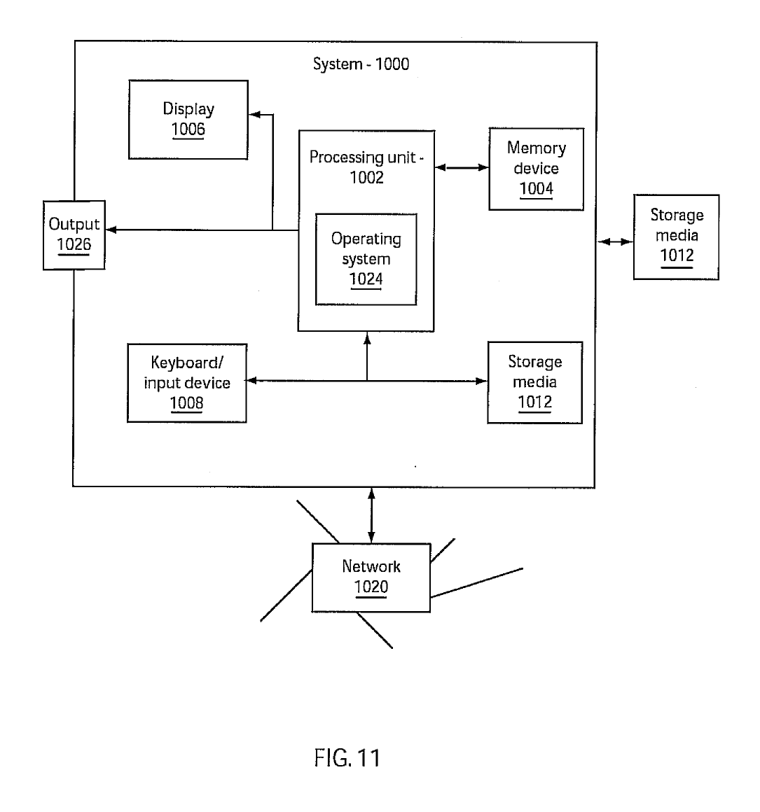

Referring to FIG. 11, a system 1000 in accordance with an illustrative embodiment may include a computing device, chip or software module. System 1000 may be embodied in a personal computer, cell phone, personal digital assistant, computer game console or the like. System 1000 includes a processing unit 1002 and a memory device 1004, a video display terminal 1006, a keyboard, or other input device (such as a mouse) 1008, storage devices 1010, such as floppy drives and other types of permanent or removable storage media 1012. Additional input devices may be included, such as for example, a joystick, touchpad, touchscreen, trackball, microphone, and the like. Removable storage media 1012 may include a disk or computer game cartridge.

The system 1000 is configured to perform the actions and steps as described above with respect to FIGS. 1-9. This may include performing programmed actions provided on storage media 1012 either through an external storage media device or an internal storage media device. For example, the storage media may include a game program, navigation program, virtual tour program or similar program configured to provide the natural speech descriptions as described in accordance with the present principles. In addition, the programs may be distributed over a plurality of systems, memories or computing devices, such as over a network. Such applications may be interactive and be implemented using multiple devices.

In one illustrative example, system 1000 constructs a natural language description of one or more objects in a virtual environment. The processing system 1002 is configured to generate an object and an environment in a virtual rendering, to determine a plurality of properties of the object and the environment given a current viewpoint in the virtual environment, and to create an object description using the plurality of properties where the object description reflects multiple display characteristics of the object in the virtual environment. The one or more memory storage devices 1004, 1012 or memory in the processing unit 1002 is/are configured to provide constructions, templates or other formats for combining object descriptions by classifying objects in the virtual environment in accordance with stored criteria. This is employed to condense a natural language description of the virtual environment. An output device 1026 is configured to output the natural language description. Output device 1026 may include a speaker which outputs synthesized speech or may include a text output displayed on display 1006.

System 1000 may be part of a network data processing system which may comprise the Internet, for example, with a network 1020 representing a worldwide collection of networks and gateways that use the Transmission Control Protocol/Internet Protocol (TCP/IP) suite of protocols to communicate with one another. The Internet includes a backbone of high-speed data communication lines between major nodes or host computers including a multitude of commercial, governmental, educational and other computer systems that route data and messages.

Network data processing system 1020 may be implemented as any suitable type of networks, such as for example, an intranet, a local area network (LAN) and/or a wide area network (WAN). The network data processing elements in FIG. 10 are intended as an example, and not as an architectural limitation for embodiments in accordance with the present principles.

Processing unit 1002 may include one or more processors, a main memory, and a graphics processor. An operating system 1024 may run on processing unit 1002 and coordinate and provide control of various components within the system 1000. For example, the operating system 1024 may be a commercially available operating system.

Having described preferred embodiments of a system and method for optimizing natural language descriptions of objects in a virtual environment (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for constructing a natural language description of one or more objects in a virtual environment, comprising:
determining a plurality of properties of an object and an environment given a current viewpoint in a virtual environment;
creating an object description using the plurality of properties where the object description reflects multiple display characteristics of the object in the virtual environment; and
combining object descriptions by classifying objects in the virtual environment to condense a natural language description.

2. The method as recited in claim 1, wherein the plurality of properties includes at least one of an angle from which the object is viewed; a distance of the object from the viewpoint; a portion of the object that is visible from the viewpoint; and values of properties of other objects also present in the environment.

3. The method as recited in claim 1, further comprising outputting a natural language description of the virtual environment.

4. The method as recited in claim 1, wherein classifying objects includes replacing sets of similar objects with a single group object and a corresponding natural language description.

5. The method as recited in claim 1, wherein classifying objects includes prioritizing a set of objects.

6. The method as recited in claim 5, wherein prioritizing is based on a state of the virtual environment.

7. The method as recited in claim 5, wherein prioritizing includes at least one of giving a highest priority to an object that is in a center of a viewpoint; maximizing spatial coherence in an ordering of objects; and determining an order of objects employing user preference information.

8. The method as recited in claim 1, further comprising composing a set of natural language descriptions of each object into a single, optimized natural language description.

9. The method as recited in claim 1, further comprising filtering a set of objects in accordance with the classifying step.

10. The method as recited in claim 1, wherein the natural language description is localized in audio space to a relative position of an object being described.

11. The method as recited in claim 1, wherein the objects are limited to at least one of a subset of the objects, and the set of objects that are visible from the current viewpoint within the virtual environment.

12. The method as recited in claim 1, further comprising triggering the method by at least one of: issuing a specific command by a user; moving a camera or avatar to a specific position in the virtual environment; achieving a particular state of the virtual environment or of a user within that environment.

13. The method as recited in claim 1, wherein the object description includes information about spatial and structural relationships between the objects.

14. A computer readable medium comprising a computer readable program for constructing a natural language description of one or more objects in a virtual environment, wherein the computer readable program when executed on a computer causes the computer to perform the steps of:
determining a plurality of properties of an object and an environment given a current viewpoint in a virtual environment;
creating an object description using the plurality of properties where the object description reflects multiple display characteristics of the object in the virtual environment; and
combining object descriptions by classifying objects in the virtual environment to condense a natural language description.

15. The computer readable medium as recited in claim 14, wherein the plurality of properties includes at least one of an angle from which the object is viewed; a distance of the object from the viewpoint; a portion of the object that is visible from the viewpoint; and values of properties of other objects also present in the environment.

16. The computer readable medium as recited in claim 14, wherein classifying objects includes replacing sets of similar objects with a single group object and a corresponding natural language description.

17. The computer readable medium as recited in claim 14, wherein classifying objects includes prioritizing a set of objects.

18. The computer readable medium as recited in claim 15, wherein prioritizing is based on a state of the virtual environment.

19. The computer readable medium as recited in claim 15, wherein prioritizing includes at least one of giving a highest priority to an object that is in a center of a viewpoint; maximizing spatial coherence in an ordering of objects; and
determining an order of objects employing user preference information.

20. The computer readable medium as recited in claim 14, further comprising composing a set of natural language descriptions of each object into a single, optimized natural language description.

21. The computer readable medium as recited in claim 14, further comprising filtering a set of objects in accordance with the classifying step.

22. The computer readable medium as recited in claim 14, further comprising triggering the program by at least one of: issuing a specific command by a user; moving a camera or avatar to a specific position in the virtual environment; achieving a particular state of the virtual environment or of a user within that environment.

23. A system for constructing a natural language description of one or more objects in a virtual environment, comprising:
a processing system configured to generate an object and an environment in a virtual rendering, the processing system being configured to determine a plurality of properties of the object and the environment given a current viewpoint in the virtual environment, and create an object description using the plurality of properties where the object description reflects multiple display characteristics of the object in the virtual environment;
a memory storage device configured to provide constructions for combining object descriptions by classifying objects in the virtual environment in accordance with stored criteria to condense a natural language description of the virtual environment; and
an output device configured to output the natural language description.

24. The system as recited in claim 23, wherein classifying objects includes replacing sets of similar objects with a single group object and a corresponding natural language description.

25. The system as recited in claim 23, wherein classifying objects includes prioritizing the objects based on a state of the virtual environment and at least one of giving a highest priority to an object that is in a center of a viewpoint; maximizing spatial coherence in an ordering of objects; and determining an order of objects employing user preference information.
